(19) United States
(12) Patent Application Publication
(10) Pub. No.: US 2012/0002289 A1
(43) Pub. Date: Jan. 5, 2012

(54) ANTI-REFLECTION DISPLAY WINDOW PANEL AND MANUFACTURING METHOD THEREOF

(76) Inventors: Eui-Sub Shin, Yongin (KR); Chang-Min Park, Yongin (KR)

(21) Appl. No.: 12/943,191

(22) Filed: Nov. 10, 2010

(30) Foreign Application Priority Data
Jun. 30, 2010 (KR) 10-2010-0062961

(51) Int. Cl. G02B 1/11; B29C 45/00; B29D 11/00

(52) U.S. Cl. 359/601; 264/2.5

(57) ABSTRACT

An anti-reflection display window panel and a manufacturing method thereof, which includes: forming a master, wherein a glass or a silicon wafer substrate is subject to light irradiation and etching to form a fine nano-pattern; preparing a nickel core plate to have on its surface the same nano-pattern; preparing an IMD core mold for the anti-reflection by attaching the nickel core plate to a particle plate of a lower mold core in an anti-reflection core mold to expose the surface of the nickel core plate formed with said fine nano-pattern; and, performing an IMD injection molding, wherein molten resin with high temperature is introduced between an upper mold core and the lower mold core and then is subject to the performance of the injection molding with a fast heating and a fast cooling to produce an anti-reflection display window panel formed with the fine nano-pattern for anti-reflection.

### BACKGROUND OF THE INVENTION

1. Field of the invention

The present invention relates to an anti-reflection display window panel and a manufacturing method thereof. More particularly, the anti-reflection display window panel and the manufacturing method thereof according to the present invention, which may be applied to a transparent display window panel for a mobile phone, a PDA phone or any kind of a personal electronic device capable of checking and using contents, provide an anti-reflection (AR) function which may solve the problem in that a user's viewing angle is obstructed due to the higher reflection of an exterior or interior light or the lower transmission of the interior light, and in that the visibility of the contents is too low. At the same time, the present invention adopts a special heat-resistant film capable of withstanding the higher temperature, and thus it is possible to attain a nice outer configuration through ink transferring performed at the time of injection molding with fast-heating/fast-cooling after printing without any posterior treatment. Accordingly, the present invention may provide the anti-reflection display window panel with the nice outer configuration.

2. Description of the Prior Art

As generally known in the art, the user's viewing angle may be degraded on the display window of the small electronic device, such as the mobile phone, because of the scattered reflection occurring on a window surface by “the outer light” or “the outer light source” from the outside as illustrated in FIG. 3. Otherwise, “incident light” from the inside of the window display may be reflected on the surface of the window to thereby relatively degrade transmission of the light. Thus, the phenomenon may occur in that it is impossible to check the contents displayed on the display window.

In order to solve the problem related to the visibility and the viewing angle, the display window product of the prior art includes an anti-reflection film for improving the visibility and the viewing angle of the panel.

Specifically, FIG. 4 illustrates one of the prior-art methods using the anti-reflection film, which is formed by multi-layered thin films to thereby improve the visibility and the viewing angle. However, such a method adopts the films with different refractive indexes, and thus the function of light reflection is degraded.

The method illustrated in FIG. 4 requires a sputtering process in which a film deposition is performed within a vacuum environment. Also, it requires using many materials. Accordingly, it leads to the more complicated process requirements, the extended process time and the higher rate of defective product.

Further, this method requires a posterior process because the film deposition should be performed after producing the display window. Accordingly, the losses of the time, the process and the product quality are unavoidable.

FIG. 5 illustrates another method for attaining the anti-reflection.

Referring to FIG. 5, a certain pattern (not denoted with a reference numeral) is formed on a display window to thereby attain the function of anti-reflection. However, although such method is effective for prevention of the reflection by means of the certain pattern, it degrades the transmission of the light. Also, the pattern should be formed after producing the display window, and thus it requires the complicated process and a number of processes.

### SUMMARY OF THE INVENTION

Accordingly, the present invention has been made to solve the above-mentioned problems occurring in the prior art, and an object of the present invention is to provide an anti-reflection display panel and a manufacturing method thereof, wherein it has an anti-reflection function as well as a nice outer design attained through an IMD injection molding with a fast heating/fast cooling.

Another object of the present invention is to provide an anti-reflection display panel and a manufacturing method thereof, wherein a special IMD injection molding structure and injection molding processes are included in order to attain the anti-reflection function.

Another object of the present invention is to provide an anti-reflection display panel and a manufacturing method thereof, wherein the IMD injection molding including fast heating/fast cooling processes, to which special, high heat-resistant film is applied, and a nickel core plate formed with a certain nano-pattern are adopted.

Another object of the present invention is to provide an anti-reflection display panel and a manufacturing method thereof, wherein no other layer is added to an anti-reflection layer.

In order to accomplish this object, there is provided a manufacturing method of an anti-reflection display window panel, said manufacturing method comprising steps of:

forming a master for an anti-reflection core, wherein a glass or a silicon wafer substrate is subject to light irradiation and etching to thereby form a fine nano-pattern on said master; preparing a nickel core plate to have on its surface the same nano-pattern as that on said master for the anti-reflection core by electro-plating the master for the anti-reflection core, which is formed with said fine nano-pattern; preparing an IMD core mold for the anti-reflection by attaching said nickel core plate to a particle plate of a lower mold core in an anti-reflection core mold to thereby expose said surface of said nickel core plate formed with said fine nano-pattern; and, performing an IMD injection molding, wherein molten resin with high temperature is introduced between an upper mold core and the lower mold core in the anti-reflection core mold and then is subject to the performance of the injection molding with a fast heating and a fast cooling to thereby produce an anti-reflection display window panel formed with the fine nano-pattern for the anti-reflection.

In accordance with another aspect of the present invention, there is provided a manufacturing method of anti-reflection display window panel, wherein said step of preparing the master for the anti-reflection core includes: preparing said glass substrate or said silicon wafer substrate; coating said substrate with a photo-resist; prebaking the substrate coated with the photo-resist; irradiating onto an upper surface of the photo-resist the light treated with certain digital signal; and, forming said fine nano-pattern on the upper surface of said substrate through developing, etching and implanting after irradiating said light.

In accordance with another aspect of the present invention, there is provided a manufacturing method of an anti-reflection display window panel, wherein after said step of preparing said IMD core mold for the anti-reflection, an ink print layer is formed on resin layer through a printing, such as a silk-screen or a Gravure, and then the ink print layer is treated with UV coating to thereby complete a heat-resistant film, and wherein said heat-resistant film is inserted between the upper mold core and the lower mold core having said nickel core plate attached thereon when performing said step of performing the IMD injection molding.

In accordance with another aspect of the present invention, there is provided a manufacturing method of anti-reflection display window panel, wherein with said heat-resistant film inserted between said upper mold core and said lower mold core having the nickel core plate attached thereon, said molten resin with the high temperature is introduced into the mold to perform ink transferring of said heat-resistant film at the same time as to perform the molding, to thereby attain an anti-reflection function on one surface of said anti-reflection display window panel by means of said fine nano-pattern of said nickel core plate and attain an outer design on an opposite surface of said anti-reflection display window panel by means of said ink transferring of the heat-resistant film when completing the injection-molding.

In accordance with another aspect of the present invention, there is provided a manufacturing method of an anti-reflection display window panel, wherein said heat-resistant film is made of a film selected from a group comprising: polypropylene, polyester, polyimide, polypropylene and polycarbonate.

In accordance with another aspect of the present invention, there is provided an anti-reflection display window panel manufactured by the manufacturing method as described herein above.

As described herein above, the anti-reflection display window panel and the manufacturing method thereof according to the present invention, which may be applied to a transparent display window panel for a mobile phone, a PDA phone or every kind of a personal electronic device capable of checking and using contents, provide an anti-reflection (AR) function which may solve the problem in that a user's viewing angle is obstructed due to the higher reflection of an exterior or interior light or the lower transmission of the interior light, and in that the visibility of the contents is too low. At the same time, the present invention adopts a special heat-resistant film capable of withstanding the higher temperature, and thus it is possible to attain a nice outer configuration through ink transferring performed at the time of injection molding with fast-heating/fast-cooling after printing without any posterior treatment. Accordingly, the present invention may provide the anti-reflection display window panel with the nice outer configuration.

### BRIEF DESCRIPTION OF THE DRAWINGS

The above and other objects, features and advantages of the present invention will be more apparent from the following detailed description taken in conjunction with the accompanying drawings, in which:

FIG. 1 is a flow chart illustrating a manufacturing method of an anti-reflection display window panel according to the present invention.

FIGS. 2a-2f illustrate manufacturing processes for the anti-reflection display window panel according to the present invention.

FIG. 3 is a schematic view of the display window according to the prior art, wherein the viewing angle is degraded due to the scattered reflection.

FIG. 4 is a schematic view of the anti-reflection layer according to the prior art, wherein the anti-reflection layer is formed by the multi-layered thin film.

FIG. 5 is a schematic view illustrating another way for attaining the function of the anti-reflection.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

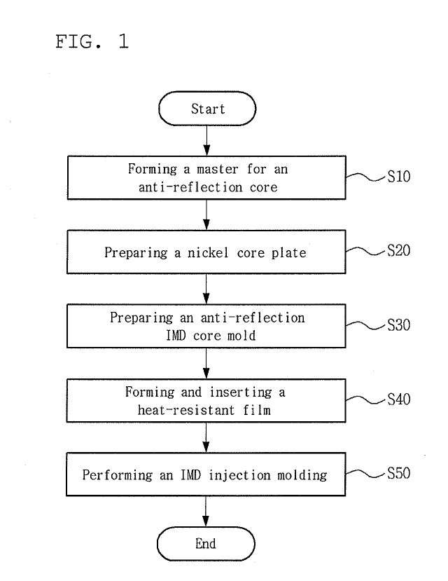

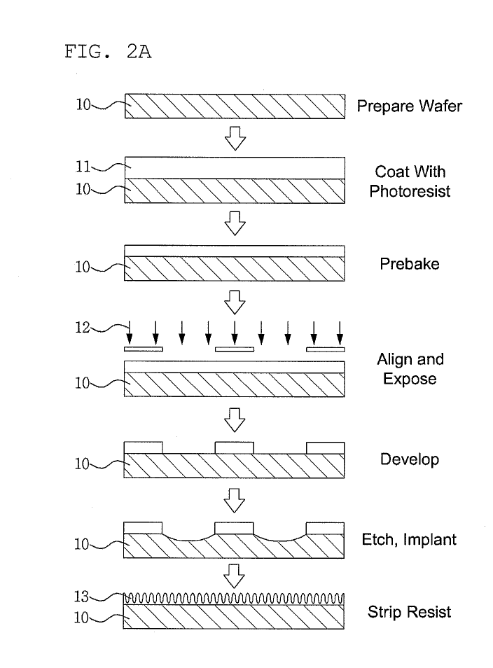

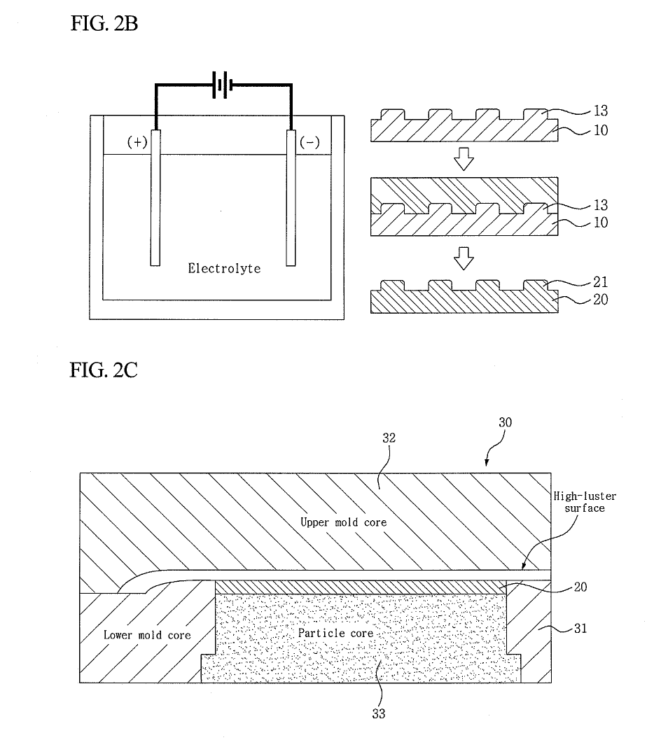

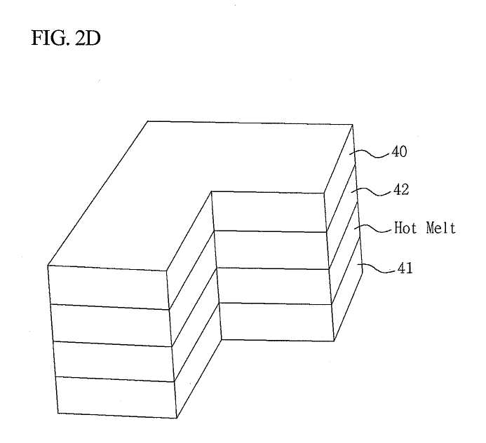

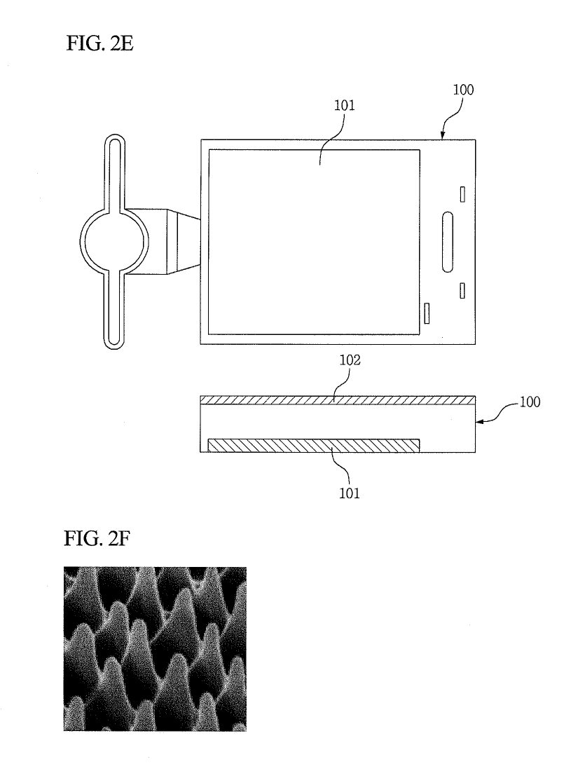

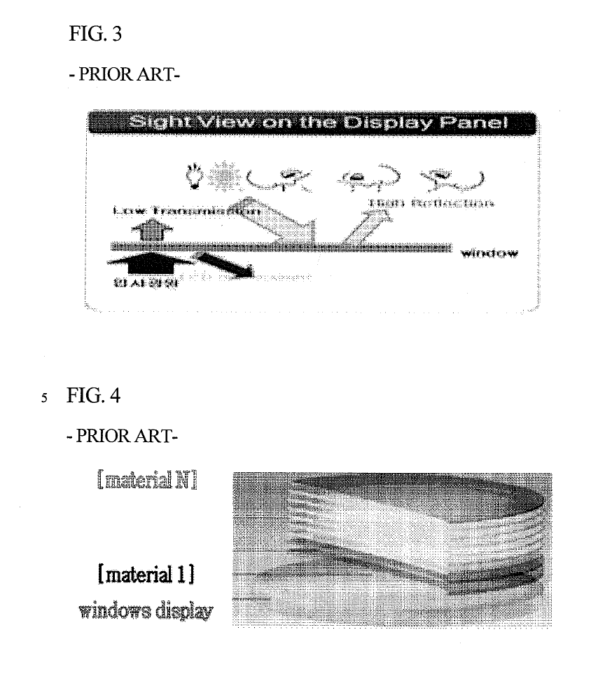

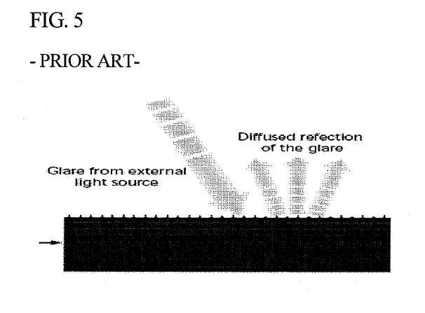

FIG. 1 is a flow chart illustrating a manufacturing method of an anti-reflection display window panel according to the present invention. FIGS. 2a-2f illustrate manufacturing processes for an anti-reflection display window panel according to the present invention.

As illustrated in the drawings, the manufacturing method of the anti-reflection display window panel of the present invention comprises the steps of: forming a master for an anti-reflection core (S10); preparing a nickel core plate (S20); preparing an anti-reflection IMD (In-Mold Decoration) core mold (S30); forming and inserting a heat-resistant film (S40); and performing an IMD injection molding (S50).

In Step (S10) of forming the master for the anti-reflection core, it includes applying certain chemicals, such as a photo-resist onto a substrate, such as a glass or a silicon wafer and irradiating light 12, which is treated with a certain digital signal, onto the surface of the substrate to thereby form a desired nano-pattern 13.

Specifically, as illustrated in FIG. 2a, the Step (S10) of forming the master (not denoted with the reference numeral) for the anti-reflection core includes: preparing the substrate 10, such as the glass or the silicon wafer; coating the photo-resist onto said substrate 10; prebaking the substrate 10 coated with the photo-resist 11; irradiating the light 12 treated with the digital signals of “1” or “0” upon the upper surface of said photo-resist 11; and forming the fine nano-pattern 13 on the upper surface of the substrate 10 through a developing, etching and implanting, which are well known in the field of the art.

Here, the master for the anti-reflection core (not denoted a the reference numeral) is not restricted in its size, and thus it is possible to vary the size of the master depending on the product size.

In the step of preparing the nickel core plate (S20), as illustrated in FIG. 2b, the master for the anti-reflection core (not denoted with a reference numeral) with the fine nano-pattern 13 is used to prepare a nickel core plate 20, which has a constant thickness and a uniform mechanical property, through an electro-plating process. Also, the nickel core plate 20 is formed to have a fine nano-pattern 21 on its surface, which has the same configuration as the fine-nano pattern 13 on the master for the anti-reflection core and corresponds thereto.

It is possible to vary the thickness of the nickel core plate 20. The thickness in the range of 1-2 mm is appropriate.

The nickel core plate 20 is subject to a polishing process for a product quality in the injection molding. Thereafter, the nickel core plate 20 is subject to a punching process in order to have a proper size for the injection molding. The nickel core plate 20 processed thus is used in an anti-reflection IMD core mold 30 as described herein below.

In the step of preparing the anti-reflection IMD (In-Mold Decoration) core mold (S30), the IMD (In-Mold Decoration) core mold 30 is prepared, which comprises an upper mold core 32 and a lower core mold 31 including a particle core therein as illustrated in FIG. 2c.

Specifically, the nickel core plate 20, which was made to have the anti-reflection function, is attached over the particle core 33 installed in the lower mold core 31 to expose the fine nano-pattern 21 when preparing the mold. The upper mold core 32, which is opposite to the lower mold core 31, is subject to a high-luster treatment on its inner surface to thereby prepare the mold.

Here, the nickel core plate 20 is assembled by means of welding or ultrasound bonding.

Further, as described herein below, the mold according to the present invention has such a structure as to enable a printed film inserted in the mold to receive a molding process and the IMD process at the same time. In the IMD process, an ink layer is transferred to the injection molding product.

In step (S40) of forming and inserting the heat-resistant film, an ink print layer 42, which is printed with a drawing and etc. through any printing method like a silk screen or Gravure printing well known in the field of the art, is formed on a resin layer 41 as illustrated in FIG. 2d. The heat-resistant film 40 is completed by means of the UV coating, which is also well known in the field of the art, over the ink print layer 42.

Regarding material for the above heat-resistant film, it may comprise: polypropylene; polyester; polyimide; polypropylene; and polycarbonate (PC). However, the present invention is not restricted to these materials, but adopts any material as long as the latter has heat-resistant property withstanding the high temperature higher than 120° C.

The heat-resistant film 40 completed thus is inserted between the upper mold core 32 and the lower mold core 31 having the nickel core plate 20 attached thereon, and then molten resin with the high temperature is introduced into the mold to perform the molding and the transferring processes at the same time, when performing the IMD injection molding as described herein below. Notwithstanding, with the use of the film and the ink not to be damaged in the high temperature, the ink print layer can be transferred to the injection molding product to thereby attain a desired graphic at the time of the IMD injection molding. Accordingly, it is possible for the injection molding product to have the nice outer configuration.

In Step (S50) of performing the IMD injection molding, with the heat-resistant film 40 inserted into a space between the upper mold core 32 and the lower mold core 31 having the nickel core plate 20 attached thereon as illustrated in FIG. 2c, the molten resin with the high temperature is introduced into the mold to perform the molding and the transferring processes at the same time. Thereby, on one surface 101 of a window panel 100, the anti-reflection function is attained by the fine nano-pattern 21 of the nickel core plate 20, while on the other surface 102 of the window panel 100, the nice outer design is attained by the ink transferring of the heat-resistant film 40. Thus, the anti-reflection display window panel 100 of the present invention is completed (see FIG. 2c).

Here, with the use of the film and the ink not to be damaged in the high temperature as described herein above, it is possible to perform the IMD injection molding under the higher temperature ranging between 120° C. and 180° C.

Meanwhile, it is necessary to adopt a fast-cooling system for cooling the high temperature of the mold after performing the injection molding once and to adopt a fast-heating system for raising the temperature of the cooled mold. In this way, the step of performing the injection molding continues. The fast cooling and the fast heating can be locally applied to a desired portion of the mold according to an appropriate time control (cycle time improvement) by means of a well-known high frequency method. The fast-cooling or the fast-heating system is well known in the field of the injection molding, and thus the detailed description thereto is not provided herein.

FIG. 2f is a photographic image illustrating the nano-pattern, which is formed on the surface 101 (the display side) of the display window panel 100 manufactured according to the above-described steps and which is able to minimize the reflection and to improve the transmission.

As illustrated in FIG. 2f, a number of the nano-patterns have top portions and bottom portions, the shapes of which are different from each other. According to the examination result, the top portion has the size ranging between 50 nm and 200 nm and the depth ranging between 100 nm and 300 nm. Thus, the display window panel of the present invention has a more excellent anti-reflection property and a higher transmissivity.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A manufacturing method of ab anti-reflection display window panel, said method comprising steps of:
forming a master for an anti-reflection core, wherein a glass or a silicon wafer substrate is subject to light irradiation and etching to thereby form a fine nano-pattern on said master;
preparing a nickel core plate to have on its surface the same nano-pattern as that on said master for the anti-reflection core by electro-plating the master for the anti-reflection core, which is formed with said fine nano-pattern;
preparing an IMD core mold for the anti-reflection by attaching said nickel core plate to a particle plate of a lower mold core in an anti-reflection core mold to thereby expose said surface of said nickel core plate formed with said fine nano-pattern; and,
performing an IMD injection molding, wherein molten resin with high temperature is introduced between an upper mold core and the lower mold core in the anti-reflection core mold and then is subject to the performance of the injection molding with a fast heating and a fast cooling to thereby produce an anti-reflection display window panel formed with the fine nano-pattern for the anti-reflection.

2. A manufacturing method of an anti-reflection display window panel as claimed in claim 1, wherein said step of preparing the master for the anti-reflection core includes:
preparing said glass substrate or said silicon wafer substrate;
coating said substrate with photo-resist;
prebaking the substrate coated with the photo-resist;
irradiating onto an upper surface of the photo-resist the light treated with a certain digital signal; and,
forming said fine nano-pattern on the upper surface of said substrate through developing, etching and implanting after irradiating said light.

3. A manufacturing method of an anti-reflection display window panel as claimed in claim 1, wherein after said step of preparing said IMD core mold for the anti-reflection, an ink print layer is formed on resin layer through a printing, such as a silk-screen or a Gravure, and then the ink print layer is treated with UV coating to thereby complete a heat-resistant film, and wherein said heat-resistant film is inserted between the upper mold core and the lower mold core having said nickel core plate attached thereon when performing said step of performing the IMD injection molding.

4. A manufacturing method of anti-reflection display window panel as claimed in claim 3, wherein with said heat-resistant film inserted between said upper mold core and said lower mold core having the nickel core plate attached thereon, said molten resin with the high temperature is introduced into the mold to perform ink transferring of said heat-resistant film at the same time as to perform the molding, to thereby attain an anti-reflection function on one surface of said anti-reflection display window panel by means of said fine nano-pattern of said nickel core plate and attain an outer design on an opposite surface of said anti-reflection display window panel by means of said ink transferring of the heat-resistant film when completing the injection-molding.

5. A manufacturing method of an anti-reflection display window panel as claimed in claim 4, wherein said heat-resistant film is made of a film selected from a group comprising: polypropylene, polyester, polyimide, polypropylene and polycarbonate.

6. An anti-reflection display window panel manufactured by a manufacturing method comprising the steps of:
forming a master for an anti-reflection core, wherein a glass or a silicon wafer substrate is subject to light irradiation and etching to thereby form a fine nano-pattern on said master;
preparing a nickel core plate to have on its surface the same nano-pattern as that on said master for the anti-reflection core by electro-plating the master for the anti-reflection core, which is formed with said fine nano-pattern;
preparing an IMD core mold for the anti-reflection by attaching said nickel core plate to a particle plate of a lower mold core in an anti-reflection core mold to thereby expose said surface of said nickel core plate formed with said fine nano-pattern; and,
performing an IMD injection molding, wherein molten resin with high temperature is introduced between an upper mold core and the lower mold core in the anti-reflection core mold and then is subject to the performance of the injection molding with a fast heating and a fast cooling to thereby produce an anti-reflection display window panel formed with the fine nano-pattern for the anti-reflection.
